(19) United States
(12) Patent Application Publication
(10) Pub. No.: US 2009/0268860 A1
(43) Pub. Date: Oct. 29, 2009

(54) Process for accelerating the breeding and conversion of fissile fuel in nuclear reactors

(76) Inventor: Yingzhong Lu, Oak Ridge, TN (US)

Correspondence Address: LU YINGZHONG, 104 HARLAND COURT, OAK RIDGE, TN, 37830, US

(21) Appl. No.: 12/378,798

(22) Filed: Feb. 20, 2009

(30) Foreign Application Priority Data
Apr. 28, 2008 (CN) 200810105349.6

(51) Int. Cl. G21C 1/07; G21G 1/02; G21C 3/22; G21C 3/28; G21C 7/32; G21C 19/00

(52) U.S. Cl. 376/172; 376/174; 376/210; 376/213; 376/264; 376/411

(57) ABSTRACT

The present invention related to a novel process for accelerating the breeding and conversion of fissile fuel in various types of nuclear reactors. In said process a movable nuclear fuel ball bed filled with a coolant creeps through the reactor core. The said process could provide higher specific power per unit fuel volume inside the reactor core and proceed on-line refueling, thus requires much less initial fissile fuel inventory per unit power output as compared with the traditional breeding or conversion reactors. The said process has full inherent safety characteristics and could follow the external power demand with the inherent negative temperature coefficient of reactivity. The said process, therefore, is a more efficient and economic approach to meeting the enormous demand of fissile fuel for the forthcoming “second nuclear era”.

### BACKGROUND OF THE INVENTION

Along with the rapid growth of the world economy and population during recent years, particularly in the fast developing world including the most populous countries China and India, enormous energy supply is required. World-wide energy shortage results in political tension that threats the world peace. On the other hand, the extensive use of fossil fuels results in excess green-house gas emission causing irreversible catastrophic global warming. The world is looking for alternative “clean” energies to mitigate the disastrous fossil fuel pollution, among which only nuclear fission energy could effectively reduce green-house gas emission by large-scale within the 21st century.

The large-scale growth of nuclear energy in the 21st century needs enormous fissile fuel inventory. The only natural fissile fuel source, uranium, consists of only 0.7% readily fissionable isotope, U-235. The rest isotope, mainly U-238, is reluctant to fission and could not used as a fissile fuel in nuclear reactor. The known exploitable reserves of natural uranium could not sufficiently support the fast growing nuclear energy in the future. In addition, the economically recoverable uranium resources are distributed in relatively small number of countries, much less than the distribution of oil reserves. The control of these resources will result in more sever international tension. Many major nuclear countries, therefore, are developing fast reactors for breeding and conversion of the more abundant “fertile element”, U-238, of the natural uranium into “artificial” fissile fuel, Pu-239, to meet the demand of future expansion of nuclear energy.

A group of developed countries, including the USA, France, Russia, UK, Japan, Germany, etc. have launched recently an international cooperative R&D program “GENIV” to develop the advanced nuclear reactors for the second nuclear era. A total of six different types of reactors are selected for in-depth study, in which four of them are breeder reactors, i.e., the sodium-cooled fast breeder (FBR hereafter), gas-cooled FBR, lead-cooled FBR, and molten-salt thermal breeder (MSBR hereafter). Presently there are more and more developing countries, such as China, joined the program. This fact implies the importance of the breeding and conversion of fissile fuel in the forthcoming “second nuclear era”.

Despite of the respective remarkable merits of these GENIV breeders, however, all these breeders have a common fatal weakness, i.e., the very long fuel “doubling time”, i.e., the time required for producing extra fissile material sufficient to fueling the second (new) breeder reactor. At present, the doubling time of the state-of-the-art commercial fast breeder reactor under design study is about 15-20 years. Considering the very long lead time required to produce sufficient Pu-239 in current LWR for fueling the first FBR, the total time from planning and building a commercial-size (e.g. 1 GWe) LWR to the start-up of the second FBR using the bred fuel from the first BFR would need about half a century! Only a few developed countries, with large-scale nuclear power plants already in operation, such as the USA, Russia, France and Japan, could benefit from their accumulated PU-239 to fueling large-scale next generation nuclear power program. All populous developing countries, such as China and India, with much less operating nuclear power plants at present, are unable to get necessary initial plutonium inventory to fueling significant number of breeders within the 21st century. The success of their ambitious nuclear programs would sorely rely on the availability of external economic natural uranium supply toward the end of this century.

Most patents related to FBR during the past two decades, such as the U.S. Pat. Nos. 4,732,729; 4,762,672; 4,777,007; 5,013,519; 5,186,890; 5,196,159; 5,660,956; etc., were focused on better safety of sodium-coolant system as well as minor improvements on the conversion ratio of fertile material. No invention on substantial reduction of the fissile fuel doubling time or greatly increase of nuclear fuel breeding ratio has been put forward. Similarly, most recent patents related to thermal converters also focused on safety issues. After all, the fatal weakness of the long doubling time of the LWR-FBR scenario could not be overcome with state-of-the-art LWR-FBR technologies. It is, therefore, an urgent need to find a new approach to accelerate the fissile material production and substantially reduce the fissile fuel “doubling time” for fueling the world's “second nuclear era”.

There are two major physical parameters determining the fissile fuel breeding rate of a breeder, i.e. (1) the breeding ratio and (2) the specific power of the fissile fuel inventory of the FBR. The first parameter, breeding ratio, depends on the fission neutron gain according to the composition of the reactor core materials, has already been optimized in current FBR design and leaves little room for further improvements. On the contrary, the other parameter, the specific power fissile fuel inventory, depends on much more factors, including the geometry of the core, the configuration of the fuel element, and the heat transfer characteristics of both the fuel and the coolant, still has plenty room for further improvements through ingenious design. A breakthrough could be made in the enhancement of the specific power of the reactor fuel and coolant flow design.

Accordingly, it is an objective of the present invention to provide a novel process to enhance the fuel specific power and accelerate the breeding-conversion of fissile fuel and accelerating the fissile fuel production in fast breeders and thermal converters.

In current FBR design, further increase of the specific power of reactor fuel is subject to a number limitations, e.g. the highest allowable fuel center and cladding temperatures, the allowable limit of pumping power caused by high pressure drop due to increased coolant flow rate, the acceleration of radiation damage of in-core structure materials, and the increase frequency of the fuel element reloading, etc.

To overcome the above-mentioned limitations, the present invention proposes a fundamental change to current design of the FBR pin-type fuel element and thermal-hydraulic design. In present invention, a movable small spherical fuel ball bed is used to replace the traditional rod-cluster fuel assemblies and change the traditional parallel-flow of coolant along the fuel rods to the cross-flow through fuel ball bed. It is estimated that the fissile fuel center and clad temperatures could be reduced substantially comparing with current rod-cluster fuel elements at the same power level. Then the specific fuel power density could be raised to a much higher level in the proposed ball-bed FBR.

Similar arguments are also applicable to the LWR converter case.

Although the use of coated particles in graphite spherical fuel balls in current Pebble Bed Modular Reactor (PBMR hereafter) has already demonstrated the unquestionable merits of the superior heat transfer characteristics of coolant flow through a ball bed and the on-line refueling of a movable fuel ball bed, the fissile fuel fraction in a coated particle is too low (<20% by particle volume for typical TRISO) and unacceptable to fuel breeding process. A new type of spherical fuel ball comprising much higher of fissile material fraction (>80% by ball volume less cavity) is proposed in present invention. These fuel balls would comprise of a thin strong clad UO2 or UC kernel with a central cavity to accommodate fission gases. To achieve high specific power density, the outside diameter of the sphere should not larger than the diameter of the fuel pin of current commercial FBR, e.g. between 5-10 mm. According to a preliminary thermal hydraulic computation, when liquid lead is used as coolant at inlet and outlet temperature of 400° C. and 700° C., respectively, the kernel center temperature of a 5 mm OD kernel could be kept well under the melting point of UO2 (˜2176° C.) at more than twice the peak core power density of the current rod-type FBR.

As compared with traditional commercial FBR design, the advantages of such novel moving spherical fuel ball bed include the following:
(1) Much higher specific fuel power due to better thermal transfer and, hence, shorter fissile fuel doubling time;
(2) Less initial fissile fuel inventory due to higher specific fuel power as well as on-line refueling and, hence, lower capital cost;
(3) Full inherent safety due to the use of movable fuel ball bed and, hence, simpler nuclear safety system and lower capital cost;
(4) More uniform deep burn-up of all fuel balls due to fuel recycling and, hence, lower reprocessing cost.

In order to apply the ball type fuel elements to PWR converter to achieve higher fuel specific power, the present invention proposes another novel “composite” ball bed configuration, i.e. fill the small fuel balls into a big spherical thin shell with a multiplicity of elliptical pores that allow the water flowing freely across and cooling the internal small fuel balls. These big composite balls (e.g. with OD 50˜100 mm) could be loaded into the PWR core barrel to form a moving big composite ball bed to replace the traditional pin-type fuel element assemblies, quite similar to a pebble-bed high temperature reactor. Since the bulk water flow goes around the big composite balls, the overall flow resistance of water through the said big composite ball-bed would be comparable to traditional PWR reactor core pressure drop. Most of the above-mentioned advantages of the moving ball-bed FBR could still be retained in the renovated or re-designed PWR converters.

### BRIEF SUMMARY OF INVENTION

With regard to the above and other arguments, the objective of the present invention is to provide a process of accelerating the breeding and conversion of fissile fuel in various types of nuclear reactors. In said process a movable nuclear fuel ball bed filled with the coolant creeps through the high-flux thin reactor core enclosed with a fertilizer blanket. The fuel ball bed could provide much higher specific power than rod-cluster fuel element of traditional FBR and other type of reactors.

Another objective of the present invention is to provide an economic and more efficient fissile fuel production process with less fissile fuel inventory to accelerate the nuclear energy growth.

A further objective of this invention is to provide a full inherently safe nuclear energy production process that could eliminate the possibility of fuel melting and the severe radiation-release accidents.

The process for accelerating the breeding and conversion of fissile fuel comprising:

(a) Prepare the spherical fuel balls and fertile balls with thin clad.

(b) Prepare a mixture of the coolant with a multiplicity of thin clad high-enrichment fuel balls and another mixture of the coolant with a multiplication of thin clad fertile balls.

(c) Distribute the fuel ball mixture and fertile ball mixture separately into the fuel region(s) and fertile region(s) of the reactor core immerged in a big coolant pool, wherein the fission energy (nuclear heat) is produced and the fissile fuel are bred and converted simultaneously.

(d) Flow the coolant through the fuel and fertile ball bed to carry out the nuclear heat generated.

(e) Flow the heated coolant into a multiplicity of heat exchangers to transfer nuclear heat to the working medium of the energy conversion plant.

(f) Operate the said reactor core with varying the primary coolant and the working medium flow rates, and following the external power demand with the inherent negative temperature coefficient of reactivity of said fuel ball bed from start-up to shut-down.

(g) Convert the heat carried by said working medium to electricity and process heat.

(h) Compensate the fuel and fertile ball burn-up with on-line refueling.

(i) Continuously discharge the used fuel balls and fertile balls from the reactor core into the ball recycling facility, wherein the used balls are inspected, sorted, and separated according to their respective burn-up level;

(j) Recycle the low burn-up fuel balls and fertile balls back to the reactor core for re-use.

(k) Store the fully burn-up, spent fuel balls and fertile balls separately in an underground on-site storage for periodically taking out for reprocessing.

(l) Reprocess the spent fuel and fertile balls in an off-site plant to produce new fissile fuel and decontaminated fertile material to fabricate new fuel balls and fertile balls.

(m) Dissipate the decay heat generated by said quasi-liquid fuel with natural circulation after reactor shutdown and said spent quasi-liquid fuel in storage into atmosphere.

Wherein the diameter of both the small clad fuel ball and fertile ball is less than 10 mm and has a central cavity less than 50% volume of the kernel.

Wherein the reactor core comprises of a fuel region, an outer fertile region, a top and a bottom fertile region, and a central coolant flow region.

Wherein the partition plates between any two regions and the outermost core barrel wall have a multiplicity of narrow crevices the width of which must be less than the diameter of the fuel and fertile balls but allows the free flowing of the coolant.

Wherein the spent fuel and fertile balls could be stored on-site for a prolonged time period until the off-site security authority representative comes to open the coded underground valve and take out the spent fuel and fertile balls to the assigned re-processing plant.

The process for accelerating the conversion of fissile fuel in thermal converter comprising:
(a) Prepare the spherical low-enriched small fuel balls with thin clad.
(b) Prepare the spherical big composite ball comprising of a thin spherical porous shell filled with a multiplicity of said low-enriched thin clad small fuel balls.
(c) Distribute the big composite balls into reactor core barrel wherein the fission energy (nuclear heat) is produced and the fissile fuel are bred and converted at the same time.
(d) Flow the coolant through the big composite ball bed to carry out the nuclear heat generated;
(e) Flow the heated coolant into a multiplicity of heat exchangers to transfer nuclear heat to the working medium of the energy conversion plant.
(f) Operate the said reactor core with varying the primary coolant and the working medium flow rates, and following the external power demand with the inherent negative temperature coefficient of reactivity of said fuel ball bed from start-up to shut-down.
(g) Convert the heat carried by said working medium to electricity and process heat.
(h) Compensate the big composite ball burn-up of with on-line refueling.
(i) Continuously discharge the used big composite balls from the reactor core into the ball recycling facility, wherein the used big composite balls are inspected, sorted, and separated according to their respective burn-up level.
(j) Recycle the low burn-up big composite balls back to the reactor core for re-use.
(k) Store the fully burn-up, spent big composite balls separately in an underground on-site storage for periodically taking out for reprocessing.
(l) Reprocess the spent big composite balls in an off-site plant to produce new big composite balls.
(m) Dissipate the decay heat generated by said big composite balls with natural circulation after reactor shutdown and said spent big composite balls in storage into atmosphere.
Wherein the diameter of the low-enrichment small fuel ball is less than 10 mm and has a central cavity less than 50% volume of the kernel.
Wherein the thin porous shell of the big composite ball has a multiplicity of narrow elliptic pores; the width of which is less than the diameter of the small fuel balls and allows the free flowing of the coolant.
Wherein the spent big composite balls could be stored on-site for a prolonged time period until the off-site security authority representative comes to open the coded underground valve and take out the spent big composite balls to the assigned re-processing plant.

### BRIEF DESCRIPTION OF SEVERAL VIEWS OF THE DRAWING

The above and other features and advantages of the present invention will now be further described in the following detailed description section in conjunction with the attached drawings in which:

FIG. 1 illustrates one embodiment of the accelerated breeding and conversion process for fissile fuel production in nuclear reactor wherein fuel ball mixture and fertile ball mixture with a high-boiling point coolant is used.

FIG. 2 illustrates an alternative embodiment of the accelerated breeding and conversion process for fissile fuel production in nuclear reactor cooling with a high-pressure gas coolant, wherein FIG. 2A illustrates the multi-cavity pre-stressed concrete pressure vessel of such a reactor and FIG. 2B illustrates the possible arrangement of various equipments inside those cavities.

FIG. 3 illustrates an embodiment of the accelerated conversion process for fissile fuel production in thermal nuclear reactor with a movable big composite ball bed to replace the traditional rod-cluster fuel elements, wherein FIG. 3A illustrates the structure of said big composite balls and FIG. 3B illustrates the great simplification of such a LWR retrofitted with using said big composite balls.

FIG. 4 illustrates the comparison curves of the specific power and fissile fuel doubling time of said full inherently safe, low cost, accelerating the breeding and conversion process vs. traditional FBR.

### DETAILED DESCRIPTION

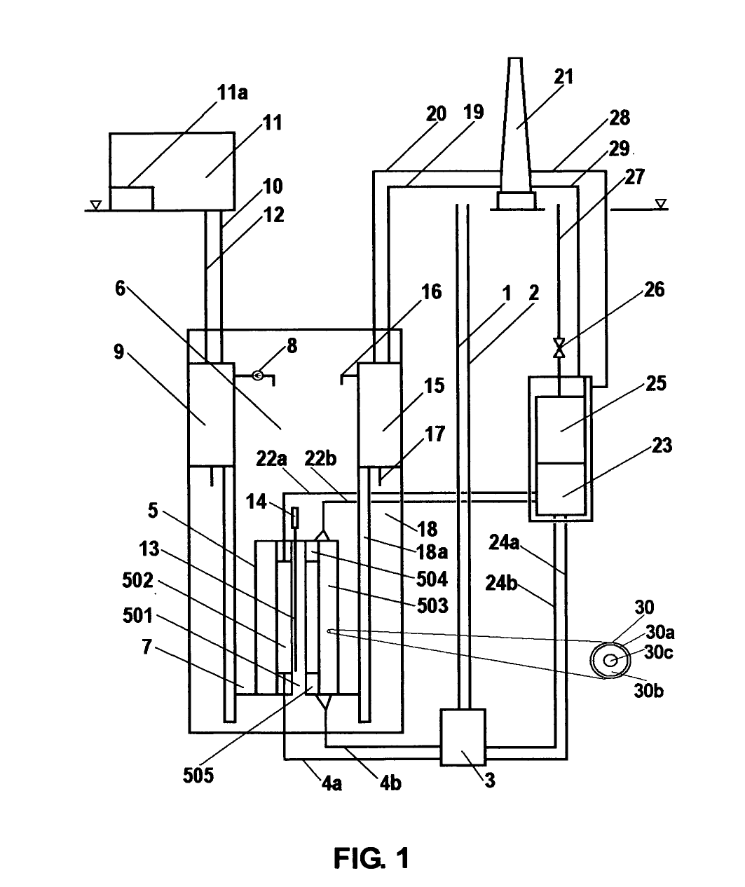

FIG. 1 illustrates one embodiment of the accelerated breeding and conversion process for fissile fuel production in nuclear reactor wherein fuel ball mixture and fertile ball mixture with a high-boiling point coolant is used.

In FIG. 1, the thin clad balls containing either fissile fuel material or fertile material (abbreviated hereafter respectively as “fuel ball” or “fertile ball”, or collectively as “nuclear ball”) and a high-boiling point coolant pellets (e.g. lead or sodium) are sent separately through nuclear ball input pipe 1 and coolant pellet input pipeline 2 into the underground nuclear fuel and fertile mixture preparation facility 3. Then the fuel mixture and the fertile mixture are sent separately into respective regions of the reactor core 5 according to the pre-determined fueling plan via fuel mixture input pipe 4a and fertile mixture input pipe 4b respectively. The reactor core is installed at the bottom of a big coolant pool 6. Since a very heavy coolant, lead, is chosen as example in FIG. 1, its specific gravity is slightly higher than the nuclear balls, all the ball input pipes 4a and 4b are located at the bottom of the reactor core 5 and the outlets 22a and 22b at the top.

The reactor core 5 comprises of three concentric cylinders and divided into five regions. The central porous cylinder is the coolant entrance plenum 501 open to the pool at the bottom end and sealed at the top. There are numerous slim elliptic pores on the central cylinder wall and all other cylinder walls. The width of these slim elliptic pores is narrower than the diameter of the nuclear balls so that the balls could not leak into the central plenum or other regions while the coolant could flow freely through the walls with little resistance. The cold coolant enters the plenum from the open bottom end, and flows up and outward through the slim elliptic pores into the surrounding annular fuel region 502 filling with fuel balls. The coolant flows horizontally across the fuel ball bed, carrying out the fission energy, and is heated up to a higher temperature. Then the hotter coolant enters the next outer annular fertile region 503, flowing horizontally across the fertile ball bed while carrying additional fission heat from the fertile balls. Finally the heated coolant reaches the outer coolant plenum 7. The hot coolant then flows upward to the top of the coolant pool, pumped through a set of heat exchangers 8 with the primary coolant transfer pumps 9.

Because the extensive heat-transfer surfaces of the fuel ball bed and the large heat transfer coefficient of the cross-flow coolant through the ball bed, the peak clad temperature would be only slightly higher than the surrounding coolant, particularly when using liquid metal coolants. As a result, given the same clad temperature upper limit, the allowable maximum exit coolant temperature in present invention could be much higher than current FBR, and, hence, a higher thermal efficiency and safety margin.

Beside the outer fertile region, a top and a bottom fertile region, 504 and 505, are attached, respectively, to the top and bottom of the annular fuel region. Inside all these fertile regions, movable fertile balls are filled. These fertile balls are of the same diameter as the fuel balls. The coolant also flows horizontally through these regions to carry out the fission heat.

All the fission products are tightly sealed inside these balls within the thin shell made of strong heat-resistant alloys, ceramic, cermets, or other refractory materials. No significant radiation fission products could leak into the coolant under all normal and accident conditions. In addition, a central cavity is provided inside the fuel kernel to accommodate the fission gases and reduce the gas pressure built-up inside the balls during operations.

In the heat exchanger 9, adequate secondary coolant or working medium carries the heat from the primary coolant via hot coolant transfer pipeline 10 to the nuclear energy conversion plant 11 to produce electricity and/or process heat. The cooled secondary coolant or working medium returns to the heat exchanger 9 via cold coolant return pipeline 12. In addition to power generation, the high temperature heat also has broad direct applications in metallurgy, petroleum industry, chemical processes, hydrogen production, sea water desalination, and district heating.

The movable mixture of fuel balls with coolant has very high negative temperature coefficient of reactivity similar to other liquid fuel reactors. The FBR of present invention, therefore, possesses excellent “full inherent safety” characteristics.

The load-following characteristics of the fuel ball-bed are excellent. The power output of the reactor would vary with the coolant flow rate. The decrease of coolant flow rate would cause both the reactor core and the coolant temperature rising, then the negative temperature coefficient of reactivity automatically reduce the reactor power, and vise versa. Stop the coolant flow or stop the circulating pump would cause the reactor core temperature would further rise to a level to automatically stop the power output, then the reactor core temperature would stay constant when all the decay heat is dissipated to the atmosphere with natural circulation of the pool coolant. The excellent self-regulating characteristics of the movable nuclear fuel make possible the unattended computer-control of the entire plant with minimum human intervention. The control computer 11a is installed in the energy conversion plant 11 wherein the operators would basically perform surveillance role of the nuclear plant. The human error accident, therefore, could be reduced to a minimum.

Because of the high thermal capacity of the coolant, the coolant temperature variation would be relatively small when the reactor output varies between start-up to full power. Mechanical power control system, therefore, is no longer required. As a result, the accidents due to control system failure and control-related operator error are basically excluded in present invention. To provide additional flexibility, a stand-by shut-down tube system 13 is also provided. When the reactor is automatically stopped, a number of tiny solid absorber balls mixed with coolant could also ejected hydraulically with a set of hydraulic mechanisms 14 into these tubes. Then the maximum temperature rise of the reactor core and coolant temperature due to decay heat generation could drop further due to the actuation of this stand-by reactor shut-down system.

The decay heat of the reactor core is dissipated with natural circulation via a set of decay heat exchangers 15. The coolant, being heated with the decay heat and lighter, rises to the top of the pool and enters these decay heat exchangers via the inlet pipe 16 and leaves via outlet pipe 17 to the pool. Then the heavier cooled coolant flows down by gravity along the annular gap 18 to the bottom of the pool, and circulates through the reactor core 5 to continuously carry out the decay heat. The ambient air enters these decay heat exchangers as secondary cooling medium, and flows upward with natural circulation via the air entry pipe 19 and discharge pipe 20 through the high chimney 21 into the atmosphere.

The diameter of the fuel ball 30 is relatively small, e.g. 2-10 mm, preferably around 5 mm—similar to the fuel rod diameter of most current FBR designs. The clad 30a is very thin and the fissile material is in the form of a hollow kernel 30b with a central cavity 30c for fission gas storage to reduce the gas pressure. The temperature gradient across the hollow fuel kernel and the clad is relatively low. As a result, the maximum attainable interior temperature of the fuel ball kernel could be kept below the melting point of uranium kernel even at very high specific power density. Since the surface area to volume ratio (S/V) of a spherical fuel element is 50% larger than the rod type fuel element with same diameter, the spherical element with a central cavity could deliver much more than 50% fission power than the same size pin element at the same maximum fuel interior temperature. The cross-flow of the coolant through a ball bed could also dissipate much more fission power to the liquid-metal coolant than the parallel-flow along the rod cluster at the same maximum clad surface temperature. The fuel melting and clad failing accident, therefore, could not be happen at all even at very high specific power density in of spherical fuel ball bed. In addition, since the pressure of the high-boiling point coolant pool could always keep slightly below the ambient atmospheric pressure, no LOCA could ever happen under any conditions. In short, the reactor of the present invention would exclude the possibility of severe nuclear accident like the “Three Mile Island” and “Chernobyl” reactors.

The configuration of the fertile ball and its overall size are identical with the fuel ball. However, because of the lower heat generation rate inside the fertile ball, the central cavity volume fraction would be much smaller than the fuel ball.

The fuel management of the movable nuclear nuclear ball bed adopts the “totally enclosed” principle, i.e. once the nuclear balls are loaded into the system, they could only be circulated, redistributed, and stored in this system as long as pre-planed. The reactor could continue its operation for many, many years without shut-down for refueling or maintenance. The nuclear balls would only “creep” slowly through the reactor core, with a velocity in the order of a couple of μm (10⁻⁶ m) per second, and continuously produce more fissile material than consumed. The present invention, therefore, could provide better security control to prevent nuclear material proliferation from commercial nuclear power plants.

In order to make all the fuel and fertile balls reach their respective maximum designed burn-up rate, the nuclear balls discharged from the reactor core are sent to the nuclear ball recycling facility 23 via the fuel and fertile ball discharge pipe 22a and 22b respectively. These used nuclear balls are inspected, sorted, and recycled or stored according to their respective burn-up levels. The under-burnt fuel and fertile balls are sent back to respective reactor core region via fuel recycling pipe 24a&4a and fertile recycling pipe 24b&4b. Only those balls achieved maximum burn-up are sent to the underground spent ball storage facility 25 for on-site storage. Because the compact size and high burn-up of these balls, the required storage volume is relatively smaller than both LWR and HTGR. Since the decay heat of the spent balls could easily be cooled with natural circulated ambient air, the safety of such medium-term underground storage could be guaranteed. The cooling air inlet and outlet pipe are respectively 28 and 29. The heated air is also discharged through the high chimney 21.

The access to the fuel material retrieval from the underground storage could be remote controlled by an off-site safeguard authority if desired. In this case, nobody could access to the fissile materials circulating inside the totally enclosed fuel system. Only the authorized representative from the off-site safeguard authority could come on schedule and contact the off-site safeguard authority control center via internet to open the secrete-coded valve 26, re-melt nuclear-coolant and draw out the ball-coolant mixture from the underground pipeline 27. The spent nuclear material is then transported under adequate security guards to the pre-assigned re-processing plant (not shown in FIG. 1).

An annular primary shield 18a is installed around the reactor core. Together with the coolant inside the annular gap 7 for coolant flow, this composite annular shielding (18a+7) protect the pool wall from the strong radiation of the high neutron flux and radiations of the FBR reactor core. The reactor coolant pool container could be kept intact longer than the design life of most other parts of the entire nuclear plant.

The excellent economy of the present invention is based on the following features: (1) the full inherent safety feature of the movable fuel ball bed eliminates nearly all redundant engineering safety systems as well as their associated auxiliary systems, as required by most traditional reactors; (2) non-nuclear grade equipment for common thermal power plants could be safely used outside the reactor building; and (3) the higher overall plant thermal efficiency due to higher outlet coolant temperature than current commercial nuclear power plants. It is expected that both the capital and the operational cost of the nuclear power plants based on present invention could be quite competitive in future energy market.

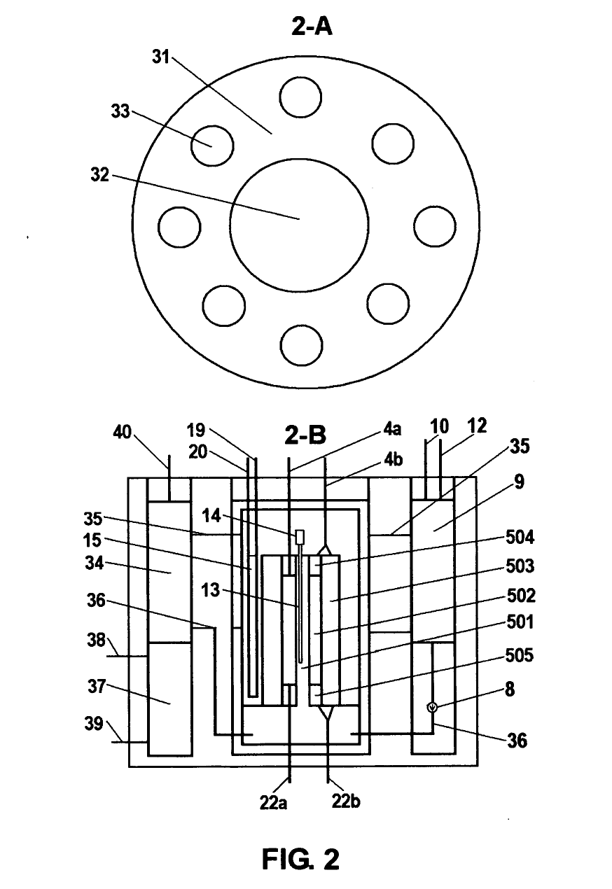

FIG. 2 illustrates an alternative embodiment of the accelerated breeding and conversion process for fissile fuel production in nuclear reactor cooling with a high-pressure gas coolant, wherein FIG. 2A illustrates the multi-cavity pre-stressed concrete pressure vessel of such a reactor and FIG. 2B illustrates the possible arrangement of various equipments inside those cavities.

In view of the well-proven experience of thermal neutron reactors using high pressure gas and water coolant in many large commercial nuclear power plants, and they are currently the only sources of Pu-239 for initial fuel loads in first generation FBR for the time being, the present invention also proposes a high specific-power modification to the traditional gas- and water-cooled thermal converter or breeder wherein the movable nuclear ball bed is used to replace the pin-type or the prism-type fuel elements. A gas-cooled ball bed reactor embodiment is described below as an example. A multi-cavity pre-stressed concrete pressure vessel (abbreviated as “MPCV” hereafter) is used to house the nuclear island. The burst-resistant characteristics of MPCV could basically prevent the LOCA accident under all reactor operation conditions.

FIG. 2A illustrates the cross-section of such MPCV 31 of the reactor. A big reactor cavity 32 is seen at the center of this MCPV, around which a number of cavities 33 are arranged for the accommodation of various equipment.

FIG. 2B illustrates the major equipment installed in those cavities, as well as a part of relevant flow diagram of the nuclear island different from FIG. 1. All the flow diagrams of the auxiliary systems identical to FIG. 1 are not shown in FIG. 2B. The main reactor systems in FIG. 2B use the same labels as FIG. 1 with the exception that the location of the nuclear ball inlets (4a and 4b) and outlets (22a and 22b) are reversed due to the density of gas coolant is far less than that of the nuclear balls.

Two different types of applicable energy conversion equipment are shown as examples, separately, in two different cavities beside the center reactor cavity. In the left side cavity, a direct-cycle power generator is shown wherein the high temperature gas coolant (e.g. helium) of the reactor core is used directly as the working medium in the gas turbine 34 for power generation. The high temperature gas coolant leaving the reactor core enters the gas turbine via coolant outlet pipe 35, passes through the gas turbine 34 and returns to the reactor via coolant inlet pipe 36. A gas cooler 37 is installed beneath the gas turbine, of which the inlet and outlet pipes of the external cooling medium (e.g. water) are respectively 38 and 39. The power generated is sent to the transformer station via the cable 40.

In the right side cavity, an indirect cycle of power generation equipment is shown. The high temperature gas first enters a heat exchanger (e.g. a steam generator), transfers the energy to a working medium, and the latter is sent to the power generation equipment to generate electricity. Since this process is identical to that of the FIG. 1, the labels are also identical, no redundant description is needed.

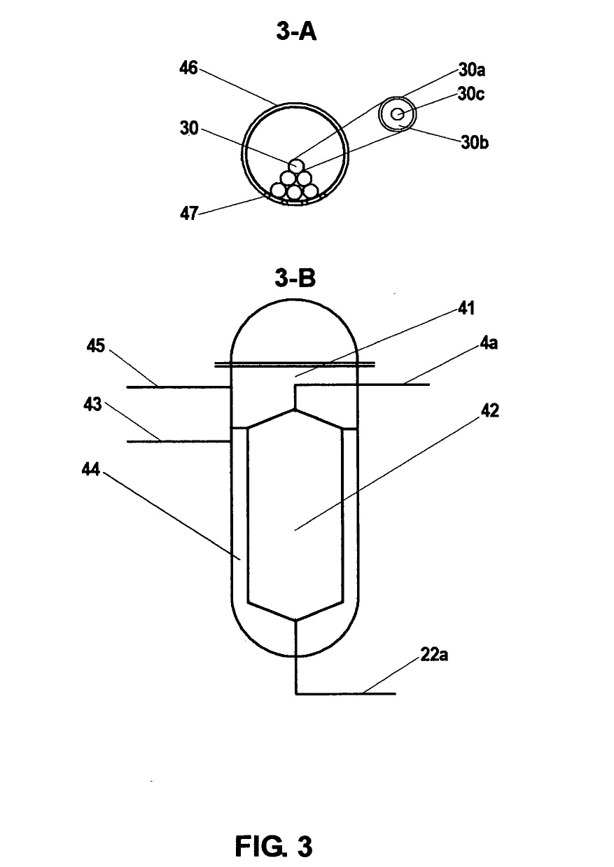

FIG. 3 illustrates an embodiment of the accelerated conversion process for fissile fuel production in thermal nuclear reactor with a movable big composite ball bed to replace the traditional rod-cluster fuel elements, wherein FIG. 3A illustrates the structure of said big composite balls and FIG. 3B illustrates the great simplification of such a LWR retrofitted with using said big composite balls.

In present invention, an innovative “big composite ball” as shown in FIG. 3A is proposed to greatly reduce the overall pressure drop for the application of movable ball bed fuel to PWR.

In PWR, a thermal converter, the fissile fuel used is low-enriched uranium and large volume of water is used as moderator material as well as coolant inside the reactor core. The temperature rise of coolant is small across the large reactor core, and, hence, the pumping power required by PWR is high. Small diameter fuel ball bed could not directly used in PWR reactor core due to the high resistance of water flow. Instead, a large diameter big composite ball element is proposed in present invention to solve the problem.

The big composite ball element comprises of a big porous spherical thin shell 46 filled with a multiplicity of small fuel balls. The diameter of the big spherical shell is more than 10 times of the small fuel ball. On the thin shell, a multiplicity of slim elliptical pores 47 are made, the width of the pore is less than the diameter of the fuel ball and would not allow the fuel ball to leak out. The small fuel ball, with a diameter <10 mm, comprises of a thin clad shell 30a and a hollow kernel 30b with a center cavity 30c for fission gas storage to reduce the fission gas pressure. Alternatively, ceramic-coated particles are also applicable but higher enriched fuel and larger core volume may be required.

In such a big composite ball bed, the bulk stream of cooling water could flow bypassing the big ball with little resistance, and a small fraction could be diverted into the big composite ball shell to cool the small fuel ball bed inside with much lower water velocity and adequate pressure drop. The fraction of water heated with small fuel balls exiting the big composite ball shell would mix with the down-stream bulk coolant and then repeat the process across the next big composite ball. With adequately design of the diameter of the big composite ball and adjustment of the water gaps between these small fuel balls, the required optimum water-to-fuel ratio of a PWR could be retained. With the diameter of the big composite ball large enough to reduce the water flow at an acceptable low pressure drop, the current PWR primary pumps could still be used.

FIG. 3B illustrates the greatly simplified structure of such a LWR retrofitted with said big composite balls.

By using the big composite ball bed concept, the new PWR core structure is greatly simplified, somewhat similar to the pebble-bed core of the current HTGR. Inside the pressure vessel, the core barrel is simply a hollow metal container 42, filled with these big composite balls that carries the small fuel balls, moving (creeping) very slowly through the reactor core. The big composite balls enter the reactor core via fuel ball inlet pipe 4a, and discharged via outlet pipe 22a to the nuclear ball recycling facility 23 as shown in FIG. 1 (not shown here). The flow of primary coolant water is similar that of the current PWR. The pressurized water enters the inlet pipe 43 and flows downward along the annular gap 44, then enters the reactor core from the bottom of the pressure vessel and flows upward through the pores on the bottom plate of the core container 42 and passes through the interior big composite ball bed into the upper plenum 41. The heated coolant in the upper plenum then flows via the outlet pipe 45 into the steam generators outside the reactor vessel (not shown in this figure). It is noted that the reactor core structure of the retrofitted PWR is much simpler than the traditional PWR core structure. Mechanical control rod cluster is no longer required in the retrofitted PWR. Because of the larger heat transfer surfaces provided by the multiplicity of small fuel balls (the surface to volume ratio of a ball is about 150% as large as the pin-type fuel element), and the larger heat transfer coefficient of the cross-flow coolant through fuel ball bed than parallel flow along rod clusters, the calculated specific power density is larger than the PWR before retrofit.

The advantages of the application of movable big composite ball bed to replace the current rod cluster fuel elements are: (1) the increase of the power output within the same size reactor core; (2) simplify the structure of the reactor core; and (3) the on-line refueling to enhance the overall plant utilization factor and eliminate the safety concerns on batch refueling operations; (4) when retrofitting current PWR, it is possible to decrease the core size and the fuel inventory without any change of the primary coolant loop equipment and the balance of the plant. These advantages would accelerate the fissile fuel conversion as well as reduce the capital and operational costs.

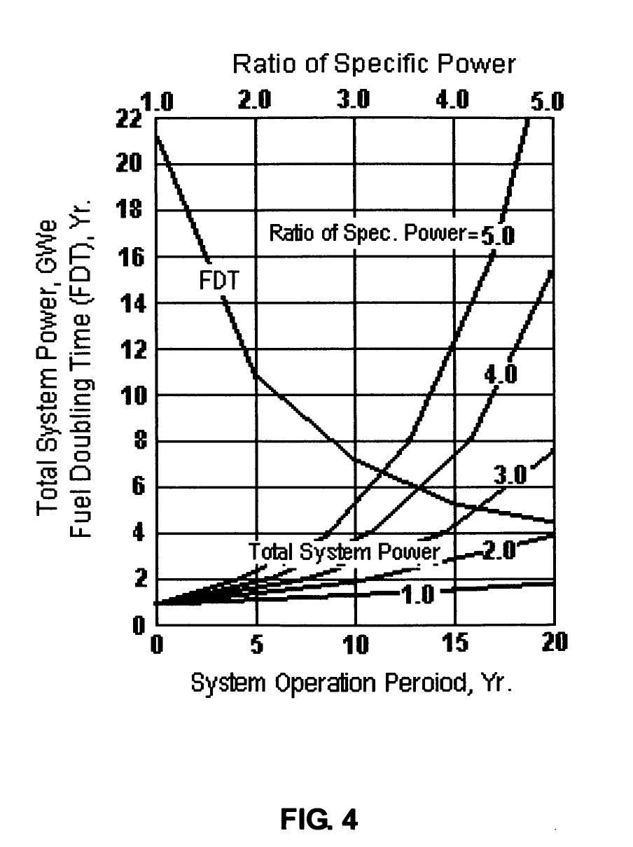

FIG. 4 illustrates the comparison curves of the specific power and fissile fuel doubling time of said full inherent safe, low cost, accelerating the breeding and conversion process vs. traditional FBR.

Assuming the maximum fuel center temperature not exceeding current FBR safety criteria, preliminary estimation of the lead-cooled FBR of present invention indicate that, for the fuel ball diameter of 5 mm and a central void 15% by kernel volume, the a average specific power could reach 3-5 times higher than that of the current commercial FBR design without exceeding the fuel element safety limits

The curves of the fissile fuel doubling time (FDT) and the accumulated total system power level attainable in the next two decades of the present invention compared with the current FBR system are given in FIG. 4.

It is noted that when the fuel specific power level increase from 2 to 5 times of the current FBR value, the FDT of present patent process could decrease from about 11 years (the current FBR is about 20 years) to about 4 years. On the other hand, the accumulated total system power level would increases exponentially with the fuel specific power. The five curves corresponding to total system power level after 20 years for 1.0, 2.0, 3.0, 4.0 and 5.0 times the specific power density (abbreviated as “SPD”) of the current FBR fuel are seen diverse widely. The total system power level in curve #1 (SPD=1.0) would only be doubled with internal breeding fuel. The total system power level in curve #2 (SPD=2.0) would be quadrupled. The total system power level in curve #3 (SPD=3.0) would increase about 8 times, and so forth. When the specific power quintupled (SPD=5.0), the total system power level after 20 years would increase about 30 times with internal breeding fuel. The increase of the fuel specific power of the FBR, therefore, is the most effective way to bring nuclear energy to a dominating role in future world energy system.

In summary, the present invention related to a novel process for accelerating the breeding and conversion of fissile fuel in various types of nuclear reactors. In said process a movable nuclear fuel ball bed filled with a coolant creeps through the reactor core. The said process could provide higher specific power per unit fuel volume inside the reactor core and proceed on-line refueling, thus requires much less initial fissile fuel inventory per unit power output as compared with the traditional breeding or conversion reactors. The said process has full inherent safety characteristics and could follow the external power demand with the inherent negative temperature coefficient of reactivity. The said process, therefore, is a more efficient and economic approach to meeting the enormous demand of fissile fuel for the forthcoming “second nuclear era”.

Having described the present invention and preferable embodiments thereof, it will be recognized that numerous variations, substitutions and additions may be made to the present invention by those ordinary skills without departing from the spirit and scope of the appended claims:

What is claimed is:

1. The process for accelerating the breeding and conversion of fissile fuel comprising the following: steps:
(a) Prepare the spherical fuel balls and fertile balls with thin clad.
(b) Prepare a mixture of the coolant with a multiplicity of thin clad high-enrichment fuel balls and another mixture of the coolant with a multiplication of thin clad fertile balls.
(c) Distribute the fuel ball mixture and fertile ball mixture separately into the fuel region(s) and fertile region(s) of the reactor core immerged in a big coolant pool, wherein the fission energy (nuclear heat) is produced and the fissile fuel are bred and converted simultaneously.
(d) Flow the coolant through the fuel and fertile ball bed to carry out the nuclear heat generated.
(e) Flow the heated coolant into a multiplicity of heat exchangers to transfer nuclear heat to the working medium of the energy conversion plant.
(f) Operate the said reactor core with varying the primary coolant and the working medium flow rates, and following the external power demand with the inherent negative temperature coefficient of reactivity of said fuel ball bed from start-up to shut-down.
(g) Convert the heat carried by said working medium to electricity and process heat.
(h) Compensate the fuel and fertile ball burn-up with on-line refueling.
(i) Continuously discharge the used fuel balls and fertile balls from the reactor core into the ball recycling facility, wherein the used balls are inspected, sorted, and separated according to their respective burn-up level;
(j) Recycle the low burn-up fuel balls and fertile balls back to the reactor core for re-use.
(k) Store the fully burn-up, spent fuel balls and fertile balls separately in an underground on-site storage for periodically taking out for reprocessing.
(l) Reprocess the spent fuel and fertile balls in an off-site plant to produce new fissile fuel and decontaminated fertile material to fabricate new fuel balls and fertile balls.
(m) Dissipate the decay heat generated by said quasi-liquid fuel with natural circulation after reactor shutdown and said spent quasi-liquid fuel in storage into atmosphere.

2. A process for accelerating the breeding and conversion of fissile fuel of claim 1 wherein the diameter of the small clad fuel balls and fertile balls is less than 10 mm and have a central cavity less than 50% volume of the kernel.

3. A process for accelerating the breeding and conversion of fissile fuel of claim 1 wherein the reactor core comprises of a fuel region, an outer fertile region, a top and a bottom fertile region, and a central coolant flow region.

4. A process for accelerating the breeding and conversion of fissile fuel of claim 1 wherein the partition plates between any two regions and the outermost core barrel wall has a multiplicity of narrow crevices the width of which must be less than the diameter of the fuel and fertile balls but allows the free flowing of the coolant.

5. A process for accelerating the breeding and conversion of fissile fuel of claim 1 wherein the spent fuel and fertile balls could be stored on-site for a prolonged time period until the off-site security authority representative comes to open the coded underground valve and take out the spent fuel and fertile balls to the assigned re-processing plant.

6. A process for accelerating the conversion of fissile fuel comprising the following steps:
(a) Prepare the spherical low-enriched fuel balls thin clad.
(b) Prepare the spherical big composite ball comprising of a thin spherical porous shell filled with a multiplicity of said low-enriched thin clad fuel balls.
(c) Distribute the big composite balls into reactor core barrel wherein the fission energy (nuclear heat) is produced and the fissile fuel are bred and converted at the same time.
(d) Flow the coolant through the big composite ball bed to carry out the nuclear heat generated;
(e) Flow the heated coolant into a multiplicity of heat exchangers to transfer nuclear heat to the working medium of the energy conversion plant.
(f) Operate the said reactor core with varying the primary coolant and the working medium flow rates, and following the external power demand with the inherent negative temperature coefficient of reactivity of said fuel ball bed from start-up to shut-down.
(g) Convert the heat carried by said working medium to electricity and process heat.
(h) Compensate the big composite ball burn-up of with on-line refueling.
(i) Continuously discharge the used big composite balls from the reactor core into the ball recycling facility, wherein the used big composite balls are inspected, sorted, and separated according to their respective burn-up level.
(j) Recycle the low burn-up big composite balls back to the reactor core for re-use.
(k) Store the fully burn-up, spent big composite balls separately in an underground on-site storage for periodically taking out for reprocessing.
(l) Reprocess the spent big composite balls in an off-site plant to produce new big composite balls.
(m) Dissipate the decay heat generated by said big composite balls with natural circulation after reactor shutdown and said spent big composite balls in storage into atmosphere.

7. A process for accelerating the conversion of fissile fuel of claim 6 wherein the diameter of the low-enrichment small fuel ball is less than 10 mm and has a central cavity less than 50% volume of the kernel.

8. A process for accelerating the conversion of fissile fuel of claim 6 wherein the thin porous shell of the big composite ball has a multiplicity of narrow elliptic pores; the width of which is less than the diameter of the small fuel balls and allows the free flowing of the coolant.

9. A process for accelerating the conversion of fissile fuel of claim 6 wherein the spent big composite balls could be stored on-site for a prolonged time period until the off-site security authority representative comes to open the coded underground valve and take out the spent big composite balls to the assigned re-processing plant.
